(19) United States
(12) Patent Application Publication
(10) Pub. No.: US 2001/0046918 A1
(43) Pub. Date: Nov. 29, 2001

(54) Gear drive transmission and method

(76) Inventor: Harold Spanski, Kent, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/797,894

(22) Filed: Mar. 1, 2001

Related U.S. Application Data
(60) Provisional application No. 60/186,265, filed on Mar. 1, 2000.

(51) Int. Cl. F16H 1/32

(52) U.S. Cl. 475/176

(57) ABSTRACT

A gear drive transmission comprising an output shaft extending between front and rear portions of a housing. At the central portion of the shaft, there is a concentrically mounted drive gear section engaging first and second ring gears. A rotational and orbiting movement of the gear drive section causes rotation of a rotatably mounted ring gear to drive the shaft. There is a feedback mechanism positioning and controlling movement of the shaft. The shaft can have a single output end or two output ends.

### CROSS RELATED REFERENCES

This application claims priority of U.S. Provisional Application Serial No. 60/186,265 filed Mar. 1, 2000.

### A. FIELD OF THE INVENTION

The present invention relates to a speed reducing gear drive, and more particularly to such a unit which is relatively compact and capable of substantial speed reduction.

### SUMMARY OF THE INVENTION

The gear drive transmission apparatus of the present invention comprises a housing having a forward housing portion, a rear housing portion, and a longitudinal axis. There is an output shaft mounted in the housing for rotation about the longitudinal axis. The shaft has a forward shaft portion mounted to the forward housing portion and a rear shaft portion mounted in the rear housing portion, and also a central shaft portion.

There is a drive transmission positioned around the central portion of the shaft. The drive transmission comprises:

i) a drive input;

ii) a drive output operatively connected to the shaft;

iii) a drive gear section positioned around the shaft for rotation about a drive axis offset from the longitudinal axis, and having an operative drive connection with the drive input;

iv) a ring gear section positioned around the shaft and having an operative drive connection with the drive output;

v) said drive gear section and said ring gear section being arranged to drive said shaft at a lower rotational speed relative to rotational speed of the drive input.

In one configuration, the forward portion of the shaft is arranged to function as a shaft power output portion of the shaft, and in another configuration both the forward and rear shaft portions function as power output portions.

Also, in preferred embodiments, there is a feedback resolver to control movement of the shaft. In one arrangement there is at least one drive motor mounted to the housing, and the feedback resolver has an operative connection to the drive motor. In one arrangement, the feedback resolver has an operative connection to the ring gear section, while in another arrangement, the feedback resolver has an operative connection to the shaft.

In one embodiment, where there is at least one drive motor mounted to the rear portion of the housing, the feedback resolver is mounted to the rear portion of the shaft and in operative engagement with the motor. Further, in a specific arrangement the feedback resolver has an adjustable connection to the shaft to enable adjustments to be made between the feedback resolver and position of the shaft.

In a preferred form, the drive input comprises an input gear concentrically mounted around the shaft. Also, there is a drive gear support section positioned around said shaft, and having a drive gear engaging surface portion concentric with said drive gear axis to cause orbiting rotational movement of the drive gear axis about the longitudinal axis.

In a preferred form, the drive input comprises an input gear concentrically positioned around the drive shaft, and a drive gear support section connected to the input gear and mounted for rotation about the longitudinal axis. Thus, the drive gear support section, with the drive gear engaging surface portion (concentric with the drive gear axis) causes orbiting rotational movement of the drive gear section about the drive gear axis. The ring gear section in a specific configuration comprises a first ring gear which has a stationary mounting to the housing. The drive gear section engages the first ring gear in a manner to cause the orbiting rotational movement of the drive gear section about the longitudinal axis. Further, in the preferred form, the ring gear section comprises a second ring gear in operative engagement with the drive gear section so that movement of the drive gear section causes a rotation of the second ring gear, with the second ring gear causing rotational movement of the shaft.

In a preferred form, the drive transmission comprises a drive sleeve positioned around the shaft so as to be able to rotate about said longitudinal axis. The drive sleeve has an outer bearing surface having a curved configuration and being in bearing engagement with a corresponding surface portion of the drive gear section. The drive sleeve has an operative connection with the drive input so that the drive input causes rotation of the drive sleeve which in turn causes orbiting rotation of the drive gear section. Desirably the drive sleeve has a forward end portion and a rear end portion, with the drive sleeve having bearing support at said forward and rear drive sleeve portions.

The drive gear section in the preferred form comprises first and second drive gear portions connected to one another and concentrically mounted on the drive gear axis. The first drive gear portion engages the first ring gear, and the second drive gear portion engages the second ring gear. The first and second drive gear portions, the first ring gear and the second ring gear are configured and dimensioned so that the rotational movement of the drive gear section causes a relatively slow rotational movement of the second ring gear relative to rotational speed of the drive input.

In one version of the invention, the first ring gear is mounted to the housing so as to be able to rotate relative to the housing when a load above a predetermined load level is placed on said first ring gear. Thus, if the shaft encounters an overload condition, the first ring gear is able to rotate to permit the shaft to remain stationary.

In the method of the present invention, the components of the apparatus are provided as described above. A rotary drive input is provided to rotate the drive gear section, which in turn operates through the ring gear section to cause a rotational output to be imparted to the shaft. The output of the shaft is through either one end of the shaft or both ends of the shaft. In those embodiments having the feedback resolver, the power drive is coordinated with the positioning of the shaft to ensure proper movement and positioning of the shaft.

Other features of the present invention will become apparent from the following detailed description.

### DESCRIPTION OF THE DRAWINGS

FIG. 1 is a longitudinal cross sectional view showing a first embodiment of the present invention, taken along line 1-1 of FIG. 3;

FIG. 2 is a sectional view taken along line 2-2 of FIG. 1;

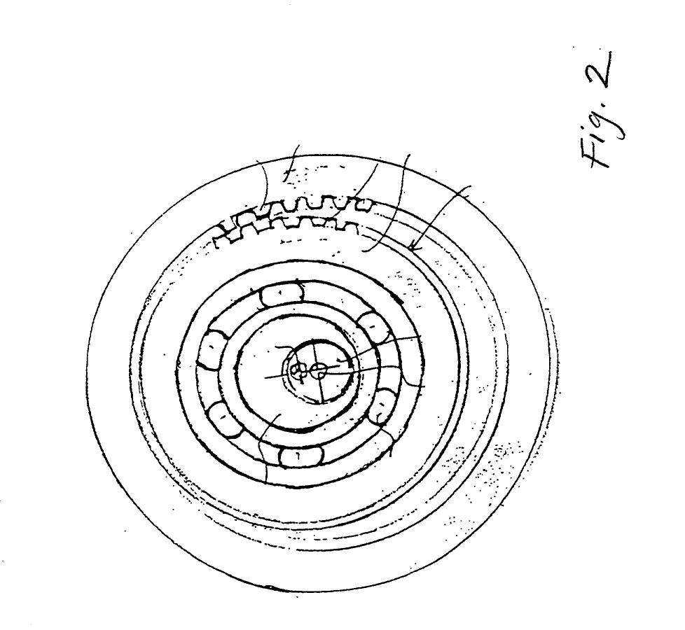

FIG. 3 is a rear elevational view of the first embodiment of the present invention;

FIG. 4 is a longitudinal sectional view of the second embodiment of the present invention; and

FIG. 5 is an end view of this second embodiment.

FIG. 6 is a longitudinal sectional view similar to FIG. 4, showing a third embodiment of the present invention;

FIG. 7 is an end view of this third embodiment taken from a rearward location of the apparatus; and

FIG. 8 is a view similar to FIG. 4 and 6 showing a fourth embodiment of the present invention.

### DESCRIPTION OF THE PREFERRED EMBODIMENTS

The unit 10 of the first embodiment of the present invention comprises a housing 12 having a rear input end 14 and the forward output end 16. At the rear end, there is a pair of electric motors 18 spaced in diametrically opposed positions from one another, each motor having a related output gear 20 located within the rear part of the housing 12. There is also a pair of feedback resolver members 22 which are spaced from one another in diametrically opposed positions, with each feedback resolver member 22 being arcuately spaced from the two motors 18 by ninety degrees.

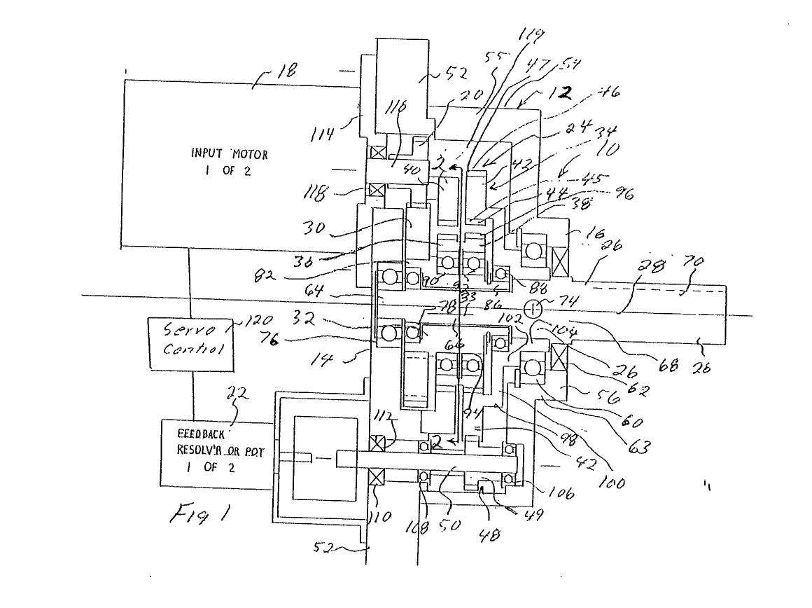

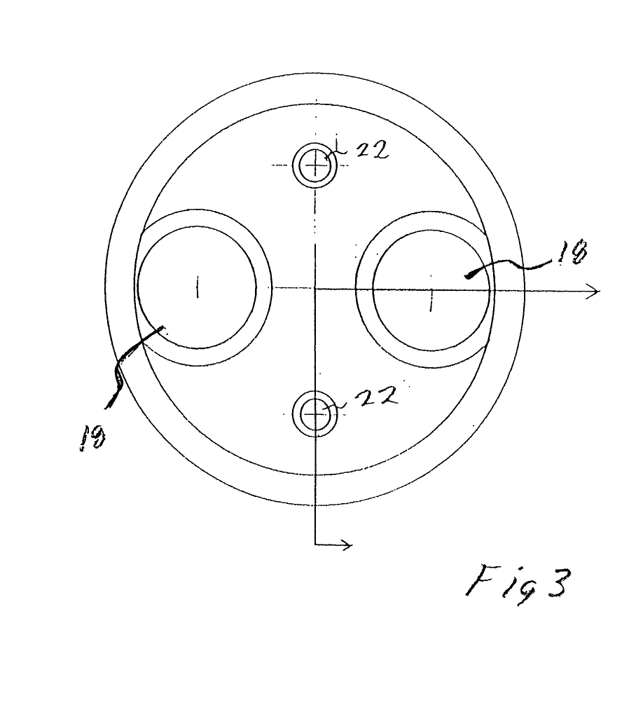

It should be noted that the longitudinal cross sectional view of FIG. 1 is taken along two longitudinal aligned planes (see FIG. 3) that meet at a 135 degree angle.

Positioned within the housing 12 is a speed reducing gear transmission 24 which is mounted to a longitudinally aligned output shaft 26 which is rotatably mounted in the housing 12 along a longitudinal center axis 28. This speed reducing gear transmission comprises an input gear 30 concentrically mounted around the rear part of the shaft 26 and in engagement with the two output gears 20 of the motors 18. The input gear 30 is connected to an eccentric drive sleeve 32 also mounted to the shaft 26 and having an axis 33 spaced from the longitudinal axis 28.

Surrounding the drive sleeve 32 is an orbiting cluster gear 34 made up of a first rear input gear section 36 and a second forward output gear section 38. There is a fixed ring gear 40 which surrounds and is in engagement with the first input gear section 36, with this fixed ring gear 40 being fixedly connected to the housing 12. There is a rotatably mounted output ring gear member 42 located forwardly of the fixed ring gear 40 and in engagement with the second output gear section 38 of the orbiting cluster gear 34.

The rotatably mounted ring gear member 42 has a radially inwardly facing drive portion 44, comprising gear teeth 45 engaging the second output gear section 38, and also a feedback portion 46 in the form of an outward circumferential set of gear teeth 47. There is a feedback mechanism 48 which comprises a pair of feedback gears 49 positioned on opposite sides of the rotatable ring gear member 42 and in engagement with the gear teeth 47 of the outer feedback portion 48 of the rotatable ring gear 42. Each feedback gear 49 is rigidly connected to the forward end of a rearwardly extending shaft 50 which in turn connects to its related feedback resolver 22. (See the lower part of FIG. 1).

The housing 12 has in cross sectional configuration perpendicular to the longitudinal center axis 28 a generally circular configuration so as to be generally symmetrical about the longitudinal center axis 28. The housing comprises a rear section 52 which is formed generally as a transversely aligned rear circular plate, and a forward housing section 54 which has a main perimeter section 55 which extends circularly to enclose the speed reducing gear transmission 24. This forward housing portion 54 also comprises a forward end portion 56 which extends radially inwardly from the forward portion of the main section 54 to close the forward end of the housing 12 and also provide support for the shaft 26. More specifically, there is a forward bearing 60 surrounding the shaft 26, and a seal 62 positioned between a forward annular protrusion 63 of the forward housing portion 54 and the shaft 26.

The shaft 26 extends along substantially the entire length dimension of the housing 12 and also extends forwardly therefrom. The shaft 26 can be considered as having four sections, and these are named in order (in a rear to forward direction) as follows: a rear end 64 by which the shaft is mounted to the rear section 52 of the housing 12, next a gear support section 66 at the location of the speed reducing gear transmission 28, next a forward support portion 68 at the location bearing member 62 and seal 63, and finally the most forward portion which is the output section 70 of the shaft 26. This output portion 70 can be splined, or be otherwise configured so as to be able to engage a member to be driven thereby. Also, the shaft 26 has a drive connection to the rotatable output ring gear member 42 so as to be driven thereby. As shown herein, this drive connection is a pin 74 which extends through the forward support portion 68 of the shaft 26 and also extending through aligned openings in the forward part of the structure of the rotatable ring gear member 42 (this to be described later herein).

The rear end 64 of the shaft 26 is supported in the rear housing section 52 by a journal bearing 76. Immediately forward of the bearing 76 is another journal bearing 78 to provide support for the input gear 30 and the eccentric drive sleeve 32. More specifically the drive sleeve 32 has a rear annular portion 82 spaced outwardly from the rear shaft portion 64, with the journal bearing 78 positioned between the shaft 26 and the annular sleeve portion 82. At the forward end of the drive sleeve 32, there is a forward annular protrusion 86 that is concentric around the longitudinal axis 26, and this in turn is surrounded by a journal bearing 88 which provides support for the rearward end of the eccentric drive sleeve 32. There are also provided two journal bearing 90 and 92 which are concentrically aligned with the output surface 94 of the eccentric drive sleeve 32. These two journal bearings 90 and 92 provide support for the orbiting cluster gear 34 which is in turn driven in its orbiting motion by the eccentric drive sleeve 32.

To describe the rotatable output ring gear member 42 in more detail, as discussed previously, the ring member 42 has the interior gear teeth 45 which come into driving engagement with exterior gear teeth 96 of the forward output gear section 38 of the cluster gear 34. Also (as indicated previously), this same portion of the ring gear 42 has the exterior gear teeth 47 that engage the two feedback gears 48. Extending forwardly from this ring gear portion 42 is a connecting section 98 of a rather short axial length, which in turn attaches to a radially inwardly portion 100 that is transversely aligned that in turn is connected to a more radially inward portion 102, which in turn connects to a portion 104 that is stepped inwardly a short distance to contain the journal bearing 88 and extend forwardly to comprise the connecting portion which is pinned (i.e. by the aforementioned pin 74) or otherwise fixedly connected to the shaft 26.

Each of the feedback shafts 50 is supported at a forward location in the housing by journal bearing 106 and supported at a more rearward location by a second journal bearing 108 located in the rear housing section 52. A short distance rearwardly of each journal bearing 108 is a seal 110 positioned in-between the annular surface 112 which defines an opening in the housing section 52 through which the feedback shaft 50 extends.

Each of the input motors 18 is mounted to the rear housing section 52 by a plate 114 through which a drive shaft 116 extends to connect to its aforementioned output gear 20. A seal 118 is positioned around each of the drive shafts 116.

Thus, it can be seen that the seals 110 for the feedback shafts 50, the seals 118 for the drive shafts 116, and the seal 62 for the output shaft 26 enclose the entire housing chamber 119 that is defined by the housing 12.

To discuss now the operation of the present invention, the four main components which are first to be considered are the input gear section 36 and the output gear section 38 of the orbiting cluster gear 34, the fixed ring gear 28 and the rotatable output ring gear 42. The electric motors 18 drive the gears 20 that drive the input gear 30 that rotates the eccentric sleeve 32 which causes the cluster gear member 34 to rotate in what can be termed an “orbiting” motion where the eccentric axis 33 rotates around the longitudinal center axis 26. Then, because of the engagement of the exterior teeth of the input gear section 36 with the gear teeth of the fixed ring gear 40, with there being a greater number of teeth in the fixed ring gear 40 than there are in the input gear section 36, there will also be a rotational movement of the entire cluster gear member 34 about the eccentric axis 33.

The effect of the engagement of the exterior gear teeth of the output gear section 38 with the gear teeth of the rotatable ring gear 42 should now be considered. As indicated above, the output gear section 38 (being integral with the input gear section 36) has the same rotational movements as the gear section 36, namely the orbiting rotational movement of the center axis 33 about the longitudinal axis 28, and also the rotational component about its own center axis 33. The effect of this is that the output ring gear 42 will have a rotational speed about the longitudinal center axis 28 which is moderately less than the rotational speed than the output gear section 38. Thus, with the output ring gear section 42 being fixedly connected to the output shaft 36, the output shaft 36 has a greatly reduced rotational velocity relative to that of the input gear 30.

At the same time, the feedback portion 47 of the rotatable ring gear 42 rotates the two resolver feedback gears 49 to in turn cause the feedback shafts 50 to rotate and thus transmit information to the two feedback resolvers 22 of the rotational velocity and/or position of the output shaft 34. This in turn is inputted to a servo control mechanism, indicated schematically at 120, which is operatively connected to the motors 18.

The combination of the drive sleeve 32 being rotatably mounted around shaft 26 and supported at end portions by bearings, and the shaft 26 extending between, and supported by, the front and rear housing portions provide spaced support locations that enhance the load handling capacity of the unit 10.

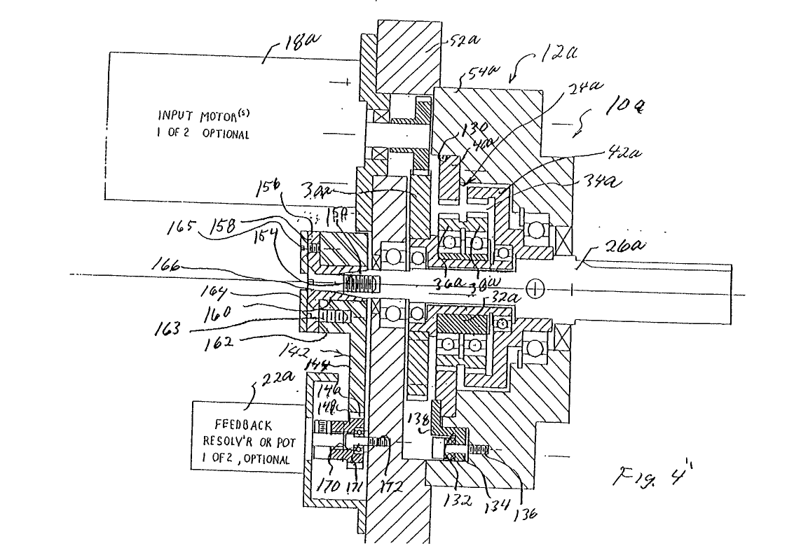

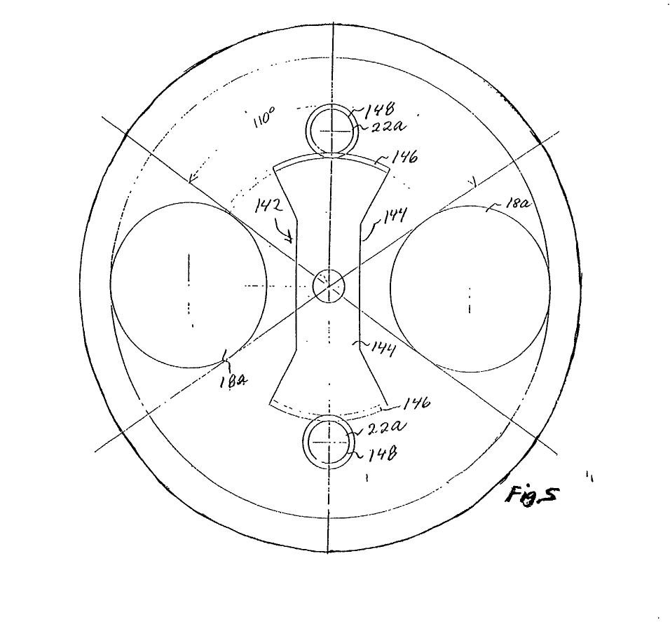

A second embodiment of the present invention will now be described with reference to FIGS. 4 and 5. Components of this second embodiment which are substantially the same, as (or similar to) components of the first embodiment will be given like numerical designations, with an “a” suffix distinguishing those of the second embodiment.

In most respects, this second embodiment is similar to the first embodiment. One of the main differences in this second embodiment is that a rather different feedback mechanism is provided, in that the feedback is directly from the main central shaft through a pair of gear segments to the feedback resolvers. Also, the fixed ring gear is mounted to the forward portion of the housing in a manner that in an overload condition it can slip. Thus, if an external force is imposed on the shaft 26a (e.g. by a rudder that is operated by the shaft encountering the ground or some object), the shaft and the drive system would slip relative to the rest of the system to prevent damage. Also, since the feedback system remains in operative engagement with the shaft 26a, the feedback system would still indicate the position of the shaft 26a accurately. In other words, the feedback system would maintain proper alignment with the output shaft 26a.

Thus, as in the first embodiment, the unit 10a comprises the housing 12a with two input motors 18a and feedback resolvers 22a. the speed reducing gear transmission 24a is located on the longitudinally aligned output shaft 26a. There is the input gear 30a, the eccentric drive sleeve 32a, and the orbiting cluster gear 34a with its gear section 36a and 38a.

The rotatable output ring member 42a is substantially the same as in the first embodiment relative to transmitting drive to the output shaft 26a. However, the feedback outer gear portion 47, the feedback gears 48 and feedback shafts 50 of the first embodiment have been eliminated from this second embodiment.

To describe the modified arrangement of the fixed ring gear 40a of this second embodiment, it can be seen that the ring gear 40a, instead of being fixedly connected to the rear housing section 52a, is mounted in an annular right angle recess 130 in the radially inward rear part of the forward housing section 54a. There are several retaining brackets 132 (one of which is shown in FIG. 4), each having a “z” configuration, with one arm 134 of the “z” being connected by a bolt 136 to the forward housing section 54a, and a second arm 138 pressing against the rear surface of the ring gear 40a. The bolts 136 can be tightened to exert the proper force against the retaining bracket 132. Alternatively these brackets 132 can be replaced by a continuous ring extending entirely around the ring gear 40a and having substantially the same Z shaped cross section of one of the brackets, 132 and connected by the bolts 132.

Thus, it can be seen that if the motors 18a are running and the output shaft 26a is somehow stopped from rotating, the rotatably mounted ring gear 42a will also stop rotating. Yet the eccentric drive sleeve will continue to rotate and this in turn will cause the interaction between the forward output gear section 38 to travel in an orbital motion to cause it to rotate. This will in turn cause a corresponding orbital motion of the input gear section 36 that will in turn cause rotation of the fixed ring gear 40a which will now be slipping in its recess 130. Thus, the two input motors 18a will continue to rotate, the shaft 26a remains stationary, and also (as will be explained below) the feedback resolver has not received any input that would indicate movement of the shaft 26a.

To describe now the feedback mechanism of the present invention, reference is again made to both FIGS. 4 and 5. With reference first to FIG. 5, it will be seen that there is a feedback member 142 that is fixedly connected to the rear end of the shaft 26a. This feedback member 142 comprises two arm portions 144 extending radially outwardly toward the two feedback resolvers 22a, these two arm portions 144 being diametrically opposite from one another. At the outer end of each arm portion 144, there is a gear segment 146 engaging a related gear member 148 that is mounted adjacent to the rear surface of the rear housing portion 52a at the location of its related feedback resolver 22a and provides feedback to the resolver 22a. Thus, it can be seen that if there is any rotational movement of the shaft 26a, the two arms 142 will also rotate a short distance to cause the gear segments 146 to cause a corresponding rotational movement of the gear member 148 connected to its related feedback resolver.

To describe the mounting mechanism by which the feedback member 142 is fixedly connected to the rear end of the drive shaft 26a, it can be seen that the rear end of the shaft 26a is formed as a tapered end portion 150 where the outside surface tapers inwardly in a rearwardly direction. The interior of the tapered end portion 150 has a threaded socket 154 which opens in a rearwardly direction.

There is an end retaining member 156 having a disc-like portion 158 and also having a cylindrically shaped rearwardly extending portion 160 having an inside surface that has a frusto-conical shape that expands in a rearward direction. This portion 160 extends around the tapered end portion 150 of the shaft. The center portion 162 of the feedback member 142 is raised so as to have a greater axial dimension, and the end disc member 158 is connected by several screws 163 to this raised center portion 162. There is also a flat end piece 164 that is retained onto the member 162 by screws 165. A main retaining screw 166 is threaded into the aforementioned threaded socket 154, and the countersunk head of the screw 166 presses against the member 156 to force the tapered arm portion 160 forwardly to come into pressing engagement with the tapered end portion 150 of the shaft 26a. Thus, by either rotating the screw 166 out of the socket or threading it further into the socket, the engagement of the retaining member 156 with the shaft 26a can either be relaxed or tightened up.

With this being done, the feedback mechanism is properly set. As power is delivered to the motor 18a to rotate the shaft 26a a short increment of travel, the rotation of the arms 144 will cause interengagement of the gear segments 146 with the related gears 148 to transmit this information through the gears 148 to the feedback dissolvers 22a.

The overall operation of this second embodiment in transmitting power from the motors 18a to the output shaft 26a is substantially the same as in the first embodiment, so this will not be described in detail.

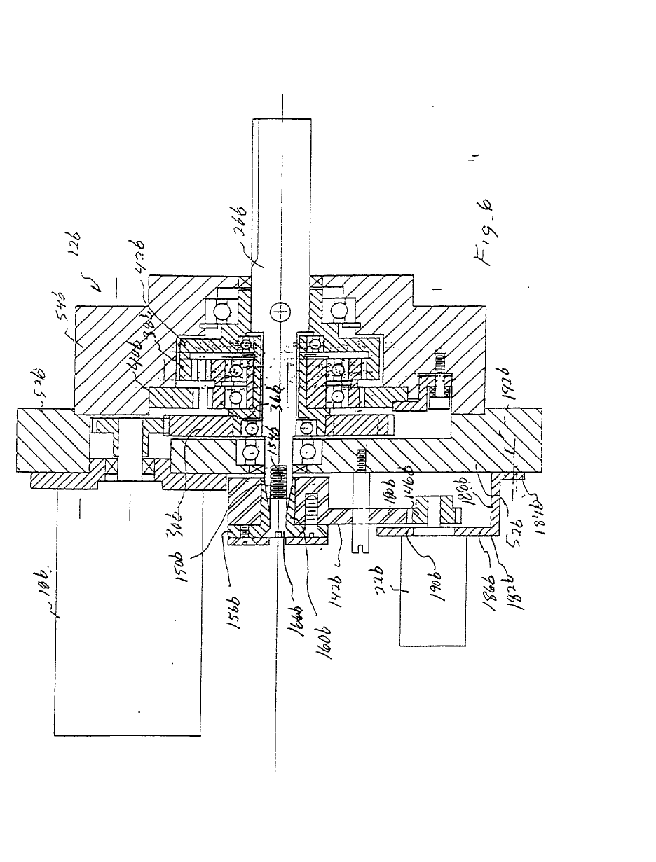

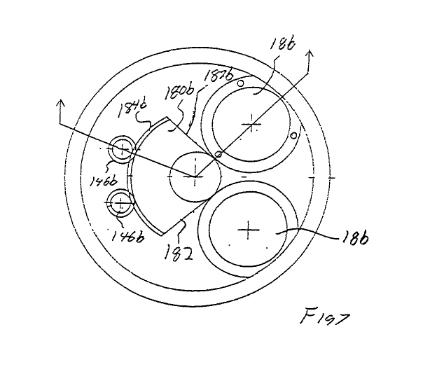

In FIGS. 6 and 7, there is shown a third embodiment of the present invention. This embodiment is quite similar to the second embodiment, and the main difference is in the arrangement of the feedback mechanism. Components of this third embodiment which are similar to components of the second embodiment will be given like numerical designations, with a “b” suffix distinguishing those of this third embodiment.

In the end view of FIG. 7, it can be seen that the two motors 18b are positioned on the same side of the apparatus, spaced about ninety degrees from one another. The two feedback resolvers 22b are on the same side of the apparatus, opposite the side on which the motors 18b are situated. For convenience of illustration, only the gear segments 146 of each of the two resolvers are shown, as being understood that the resolvers 22b are in the location of those gears 146b as shown in FIG. 7.

Instead of having the two diametrically opposed arms 144 in the feedback mechanism 142, as in the first embodiment, the feedback actuating member 180b is shaped generally as a section of a circle, having two edges extending outwardly from a center axis of rotation (with the inner ends offset slightly away from the axis of rotation), these two side edges 182 being at an angle of about one hundred and eighty degrees from one another. Then there is a gear segment 184b which extends in approximately a ninety degree curve. This gear segment 184b in turn engages the two gear segments 146b which are in turn in operative engagement with the feedback resolvers 22b.

Also, it will be noted that the gear actuating member 180b is spaced a short distance away from the adjacent housing member 52b.

With reference now to FIG. 6, it will be noted that the two feedback resolvers 22b are mounted to a bracket 186b that has a mounting flange 186b that is positioned against the housing member 52b. The bracket 186b has a rearwardly extending arm section 188b and then the actual mounting plate 190b. The connecting member indicated in the broken line at 192b is an adjustable connecting member, such as an elongate slotted opening in the flange 184b and a screw member entering into a threaded socket in the housing member 52b, so that the mounting bracket 182b can be moved radially inwardly or outwardly a short distance. This permits the gear member 146b to be positioned properly so that the gears 146b mesh with the gears of the gear member 180b.

The feedback mechanism basically operates in the same manner as that of the second embodiment, the main difference is simply the substituting of the one gear segment for two gear segments, and the positioning of the motors 18b and the feedback resolvers 22b. The remainder of the components of this third embodiment operate in substantially the same way as the second embodiment.

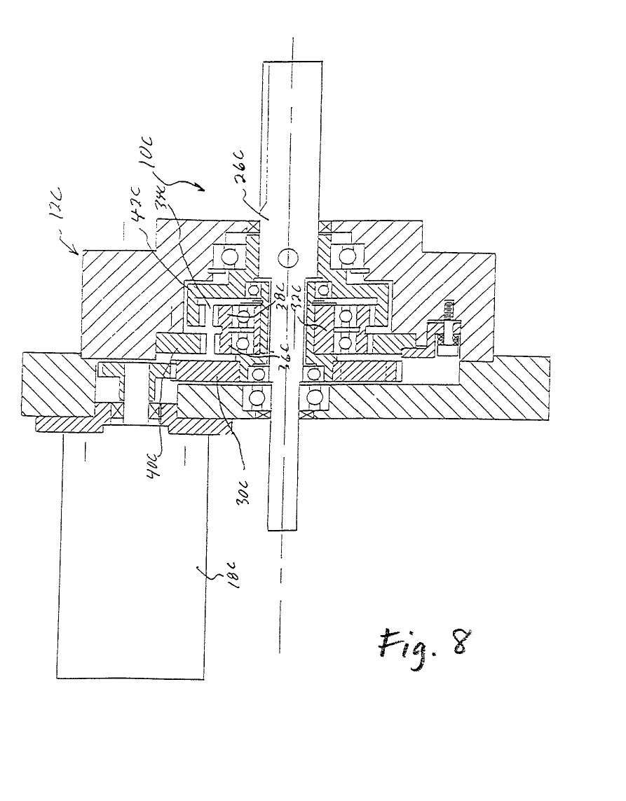

A fourth embodiment of the present invention will now be described with reference to FIG. 8. Components of this fourth embodiment which are substantially the same, as (or similar to) components of the second embodiment will be given like numerical designations, with a “c” suffix distinguishing those of the fourth embodiment.

In most respects, this fourth embodiment is similar to the first embodiment. One of the main differences in this fourth embodiment is that the shaft 26c extends both forwardly and rearwardly from the unit 10c so as to have both forward and rear power outputs. Also, in this fourth embodiment a feedback mechanism is not incorporated. However, if desired a feedback mechanism such as shown in the other embodiments could be utilized.

Thus, as in the second embodiment, the unit 10c comprises the housing 12c with one or two input motors 18c. There is a speed reducing gear transmission 24c located on the longitudinally aligned output shaft 26c. There is the input gear 30c, the eccentric drive sleeve 32c, and the orbiting cluster gear 34a with its gear section 36c and 38c. The rotatable output ring member 42c is substantially the same as in the first embodiment relative to transmitting drive to the output shaft 26a. There is the fixed ring gear 40c.

With the shaft 26c extending both forwardly and rearwardly from the housing 1 2c, the shaft 26c can drive two separate loads simultaneously.

The overall operation of this fourth embodiment in transmitting power from the motors 18a to the output shaft 26a is substantially the same as in the first embodiment, so this will not be described in detail.

It is obvious that various modifications can be made to the present invention without departing from the basic teachings thereof.

Therefore I claim

1. A gear drive transmission apparatus, comprising:
a) a housing having a forward housing portion, a rear housing portion, and a longitudinal axis;
b) an output shaft mounted in said housing for rotation about said longitudinal axis, said shaft having a forward shaft portion mounted in said forward housing portion, a rear shaft portion mounted in said rear housing portion, and a central shaft portion;
c) a drive transmission positioned around the central portion of the shaft, said drive transmission comprising:
i) a drive input;
ii) a drive output operatively connected to said shaft;
iii) a drive gear section positioned around said shaft for rotation about a drive axis offset from said longitudinal axis, and having an operative drive connection with said drive input;
iv) a ring gear section positioned around said shaft having an operative drive connection with said drive output;
v) said drive gear section and said ring gear section being arranged to drive said shaft at a lower rotational speed relative to rotational speed of said drive input.

2. The apparatus as recited in claim 1, wherein the forward portion of the shaft is arranged to function as a shaft power output portion of said shaft.

3. The apparatus as recited in claim 1, wherein the forward and rear shaft portions are arranged to function as forward and rear shaft power output portions of the shaft.

4. The apparatus as recited in claim 1, further comprising a feedback resolver to control movement of the shaft.

5. The apparatus as recited in claim 4, comprising at least one drive motor mounted to said housing, said feedback resolver having an operative connection to said drive motor.

6. The apparatus as recited in claim 4, wherein said feedback resolver has an operative drive connection to said ring gear section.

7. The apparatus as recited in claim 4, wherein said feedback resolver has an operative connection to said shaft.

8. The apparatus as recited in claim 7, wherein there is at least one drive motor mounted to a rear portion of said housing, and said feedback resolver is mounted to the rear portion of the shaft and in operative engagement with said motor.

9. The apparatus as recited in claim 8, wherein said feedback resolver has an adjustable connection to said shaft to enable adjustments to be made between the feedback resolver and position of the shaft.

10. The apparatus as recited in claim 1, wherein said drive input comprises an input gear concentrically mounted around said shaft.

11. The apparatus as recited in claim 10, wherein there is a drive gear support section positioned around said shaft and having a drive gear engaging surface portion concentric with said drive gear axis to cause orbiting rotational movement of the drive gear axis about said longitudinal axis.

12. The apparatus as recited in claim 1, wherein said drive input comprises an input gear concentrically position around said drive shaft, and a drive gear support section connected to said input gear and mounted for rotation about said longitudinal axis, said drive gear support section having a drive gear engaging surface portion which is concentric with said drive gear axis to cause orbiting rotational movement of said drive gear section about the drive gear axis.

13. The apparatus as recited in claim 12, wherein said ring gear section comprises a first ring gear which has a stationary mounting to said housing, and said drive gear section engages said first ring gear in a manner to cause the orbiting rotational movement of the drive gear section about the longitudinal axis.

14. The apparatus as recited in claim 13, wherein said ring gear section comprises a second ring gear in operative engagement with said drive gear section so that movement of the drive gear section causes a rotation of the second ring gear, with said second ring gear causing rotational movement of the shaft.

15. The apparatus as recited in claim 1, wherein said drive transmission comprises a drive sleeve positioned around said shaft so as to be able to rotate about said longitudinal axis, said drive sleeve having an outer bearing surface having a curved configuration and being in bearing engagement with a corresponding surface portion of said drive gear section, said drive sleeve having an operative connection to said drive input so that the drive input causes rotation of said drive sleeve which in turn causes orbiting rotation of said drive gear section.

16. The apparatus as recited in claim 15, wherein said drive sleeve has a forward end portion and a rear end portion, and said drive sleeve has bearing support at said forward and rear drive sleeve portions.

17. The apparatus as recited in claim 16, wherein said drive input comprises a drive input gear mounted for rotation about said longitudinal axis and connected to said drive sleeve.

18. The apparatus as recited in claim 1, wherein said drive gear section comprises first and second drive gear portions connected to one another and concentrically mounted on said drive gear axis, and said ring gear section comprises a first ring gear which is mounted to said housing so as to be stationary relative to said housing, and a second ring gear mounted so as to be rotatable relative to said housing, said first drive gear portion being in engagement with said first ring gear so that rotational movement of said first drive gear portion and the resulting rotation of said second drive gear portion causes rotational movement of said second ring gear which in turn causes rotation of said shaft, said drive gear section and said ring gear section being configured and dimensioned so that the rotational movements of the drive gear section causes a relatively slow rotation of the second ring gear relative to rotational speed of the drive input.

19. The apparatus as recited in claim 18, wherein said first ring gear is mounted to said housing so as to be able to rotate relative to said housing when a load above a predetermined load level is placed upon said first ring gear, whereby if the shaft encounters an overload condition, said first ring gear is able to rotate to permit the shaft to remain stationary.

20. A method of providing a rotary drive input of a relatively high rotational speed through a drive transmission to cause a rotary output of a relatively slow rotational speed said method comprising:
a) providing a housing having a forward housing portion, a rear housing portion, and a longitudinal axis;
b) mounting an output shaft in said housing for rotation about said longitudinal axis and supporting said shaft at a forward shaft portion mounted in said forward housing portion and at a rear shaft portion mounted in said rear housing portion;
c) positioning a drive transmission around the central portion of the shaft;
d) rotating a rotary drive input to rotate a drive gear section of said transmission positioned around said shaft to cause rotation of said drive gear section about a drive axis offset from said longitudinal axis;
e) causing a ring gear section positioned around said shaft to rotate by engagement with said drive gear section output to cause said ring gear section to drive said shaft at a lower rotational speed relative to rotational speed of said drive input.
